(19) United States
(12) Patent Application Publication
(10) Pub. No.: US 2009/0107067 A1
(43) Pub. Date: Apr. 30, 2009

(54) Safety caps for foundation rebar, stakes and anchor bolts and methods of use

(76) Inventor: Josh Beery, Fresno, CA (US)

Correspondence Address: MARK D MILLER;KIMBLE, MACMICHAEL & UPTON, 5260 NORTH PALM AVENUE, SUITE 221, FRESNO, CA, 93704, US

(21) Appl. No.: 11/980,045

(22) Filed: Oct. 29, 2007

(51) Int. Cl. F16P 1/00

(52) U.S. Cl. 52/301

(57) ABSTRACT

The present invention is a safety cap that may be used with exposed construction rebar, studs, anchor bolts, stakes or shafts of various sizes and shapes to minimize potential impalement injuries suffered by any individual falling upon the exposed shaft. The invention includes a specially shaped collar for receiving differently sized shafts so that the same device may be used on a variety of different shafts. The collar includes inwardly extending deformable flanges that temporarily but securely attach the safety cap to the shaft. Embodiments of the invention may be brightly colored for visibility and reinforced to insure that the invention does not deform or break when downward pressure is asserted upon it.

### BACKGROUND OF THE INVENTION

1. Field of the Invention

The present invention relates to safety devices for the construction industry, and more particularly to new and improved safety caps for use in building construction where rebar, studs, flat or round stakes and/or anchor bolts of varying sizes and shapes are used or installed, and related methods of use.

2. Description of the Prior Art

Metal reinforcement bars (rebar) are commonly used in concrete construction to provide added stability to concrete structures. In typical construction, a frame or web of metal reinforcement bars is typically constructed, and then concrete is poured around and over the frame. This provides internal strength and stability to the frame. However, it is common for such rebar frames to be very large, taking days or even weeks to assemble before any concrete is poured. During this time, the ends of individual bars often protrude outward where they can be a tripping or impalement hazard to workers on the job site. Then, even after the concrete is poured, in many situations some rebar or studs may still protrude outward from the concrete, posing the same tripping and impalement hazard.

Metallic anchor bolts are commonly used in the construction industry to secure building structures to concrete or other foundations. Such bolts are especially used in environments susceptible to geographic instabilities or natural disasters (such as earthquakes, floods or mudslides), or where the structures are to be constructed on steep or uneven land grades.

The anchor bolts themselves may be of varying sizes and shapes, depending upon the particular requirements of the construction project and the characteristics of the materials used. For example, larger anchor bolts (both in terms of length and diameter) may be used to secure the exterior frame of a multi-story building structure, while smaller bolts may be used to secure the internal walls of the same structure, or the exterior frame of a single-story structure. Anchor bolts may also come in different shapes with different cross sections such as circular; oval, square, rectangular, polygonal and the like.

Regardless of their particular sizes or shapes, the installation of metallic anchor bolts is a straightforward process. In concrete foundations, the bolts are vertically set at pre-determined locations throughout the foundation site before the concrete is poured. As the concrete is poured, substantial lengths of the bolts are left exposed in order to provide attachment bases for the building structures. Once the concrete has set, the structures are framed and constructed around the bolts, allowing the bolts to secure the structures to the foundation. Anchor bolts may also be used with wood frame foundations.

In the building industry, wooden boards are generally used to create the frames for concrete foundations. These frames are generally held in place using stakes that are pounded into the ground and nailed or otherwise attached to the wooden frame boards to hold them in place. These upwardly extending stakes remain present to hold the wooden frame boards during the pouring and setting of the concrete foundation.

Unfortunately, exposed rebar, studs, anchor bolts and/or framing stakes give rise to numerous safety concerns and can lead to construction site injuries. In many cases, anchor bolts are manufactured to be short and narrow in order to minimize the cost and weight of the construction materials. It is common for only a short portion of an anchor bolt to protrude up from the foundation, although these portions may be lengthy depending on the requirements of the particular building. The exposed rebar, studs, anchor bolts and/or framing stakes become tripping hazards at the construction site, and also pose a risk of impalement to any individual who may happen to fall onto one of them. These hazards are compounded by the constant movement of materials and personnel, and the limited fields of view, at the construction site.

To address these safety concerns, many companies and government entities have regulations requiring exposed rebar, studs, anchor bolts and/or framing stakes to be covered with colorful or otherwise easily identifiable safety caps. Other regulations may govern the size and/or pliability of the caps in order to minimize impalement injuries, or impose any number of additional restrictions. Safety caps such as that disclosed in U.S. Pat. No. 6,857,235 have been developed for this purpose. Unfortunately, such inventions suffer from the limitation of only being useable on round rebar or anchor bolts, and cannot be used on rectangular shafts such as those used as framing stakes. This is problematic in that a single construction site may utilize numerous rebar, studs, anchor bolts and/or framing stakes of varying sizes, dimensions and shapes, depending upon the particular function of each. Such a variety requires a significant amount of time-consuming effort to locate and install a different type of safety cap on each exposed item. Furthermore, if there is a shortage of the correct caps, additional caps must be located and installed before the work can commence or continue, all of which may result in substantial delays to the project and/or increase the amount of necessary labor.

It is therefore desirable to provide a single safety cap that may be securely attached to any of a variety of rebar, studs, anchor bolts and/or framing, stakes of varying sizes, dimensions and/or shapes (flat or round). It is further desirable that such safety caps be easily attached and removed, as necessary. It is desirable that the safety caps be sufficiently identifiable and strong to minimize construction site injuries. Finally, it is desirable to be able to provide safety caps for use with rebar, studs, anchor bolts and/or framing stakes that may be re-used.

### SUMMARY OF THE INVENTION

The present invention provides safety caps and related methods of use that may be employed with a variety of rebar, studs, anchor bolts and/or framing stakes commonly used in the construction industry having different sizes, dimensions and/or shapes. The safety caps of the present invention include a collar that fits around a rebar, stud, anchor bolt or framing stake, an upper surface that covers the top end of the rebar, stud, bolt and/or stake, and a plurality of deformable interior flanges that press against the rebar, stud, anchor bolt and/or stake to hold the cap in place. In some embodiments, the upper surface is reinforced with a metallic or other sturdy rigid material to prevent the cap itself from breaking if someone or something falls on it after installation on a rebar, stud, anchor bolt and/or stake.

The collars of the present invention are provided in a form that allows the same cap to be used on a variety of different rebar rebar, studs, anchor bolts and/or stakes having different cross sectional shapes. In the preferred embodiments, the walls of the collar have a generally rectangular cross-sectional shape, with outwardly protruding convex or arcuate walls along the longer opposing sides. These curves in the walls allow the collar to receive rebar, studs, anchor bolts and/or stakes having a round, oval, square, hexagonal or other bulging shape. The generally rectangular form of the collar walls also allows each collar to receive rebar, studs, anchor bolts and/or stakes having a generally rectangular cross-sectional shape. Different embodiments of the present invention are therefore capable of alternative uses with rebar, studs, anchor bolts and/or stakes having rectangular, round, square, oval, hexagonal or other cross-sectional shapes. It is to be appreciated that embodiments of the present invention may be provided in different sizes so as to be sufficiently large to receive numerous sizes of rebar, studs, anchor bolts and/or stakes commonly used in the construction industry.

The collars of the present invention also include sturdy but deformable inwardly protruding flanges. These flanges are attached to the inside surfaces of the walls of the collar, and protrude inwardly toward the center or central axis of the collar. The flanges are designed and positioned so as to come into contact with a rebar, stud, anchor bolt and/or stake that is inserted into the collar. The flanges are bent aside or deformed by the inserted rebar, stud, anchor bolt and/or stake, and press against it as long as it remains inside the collar. As discussed in greater detail below, these deformable flanges allow the present invention to be used with rebar, studs, anchor bolts and/or stakes of different sizes and shapes by gripping said rebar/stud/bolt/stake and holding it in place without necessitating any direct contact with the walls of the collar itself. A sufficient number of flanges are provided around the central opening of the collar to provide a firm grip of the rebar/stud/bolt/stake inserted into the collar. In preferred embodiments, the flanges may extend in a generally radial direction toward a central axis of the collar, however in other embodiments, the flanges may have different positions or orientations for engagement with different or selected places on a rebar/stud/bolt/stake inserted into the collar. The illustrated exemplary embodiment shows six flanges, but as few as four or as many as a dozen (or more) flanges may be used to provide the desired grip.

The exterior safety surface of the caps of the present invention may be of any shape and/or size. In preferred embodiments, the upper portion of a cap of the present invention is provided in the form of a widened, flattened disc attached to a collar below, with support ribs extending between the exterior of the collar and the underside of the disc. The support ribs help insure that the safety surface does not deform or shatter when downward force (such as the weight of a human body) is asserted upon the present invention. Other shapes (e.g. a dome or head) may be used in other embodiments, so long as the safety surface is of a sufficient shape and size to minimize impalement injuries. The coloring of the exterior of the caps of the present invention is preferably bright so as to make the caps readily recognizable on the construction site.

Installing the caps of the present invention is relatively simple. If the rebar, stud, anchor bolt, or stake over which the cap is to be placed has a symmetrical cross sectional shape (e.g. circular, oval, square, hexagonal, or the like), the cap is placed over the rebar/bolt/stake/stud such that it extends into the collar along the central axis thereof. The deformable interior flanges engage the sides of the rebar/bolt/stake/stud and hold the cap in place over it. It is not necessary that the rebar/bolt/stud/stake be positioned exactly along the central axis of the collar, but it should be close enough to center for the cap to slide down over it. In most embodiments, the pressure from the deformable flanges ordinarily tends to center the cap over the rebar/bolt/stud/stake.

It is therefore an object of the present invention to provide a universal safety cap that may be securely engaged over rebar, studs, anchor bolts or stakes of varying sizes and shapes.

It is a further object of the present invention to provide safety caps for engagement over protruding rebar, studs, anchor bolts or stakes that may be easily attached and removed, as desired.

It is a further object of the present invention to provide methods and apparatus for improving safety at building construction sites by providing easily attached, brightly colored and sturdy coverings for upstanding rebar, studs, anchor bolts and/or stakes in order to help prevent persons from tripping over them or impaling themselves on them.

Additional objects of the present invention will be apparent from the detailed descriptions and claims provided below.

### BRIEF DESCRIPTION OF THE DRAWINGS

FIG. 1 is a perspective environmental view of several exemplary safety caps of the present invention attached over cylindrical concrete anchor bolts and over rectangular framing stakes.

FIG. 2 is a side perspective view of an embodiment of the present invention engaged over a cylindrical anchor bolt.

FIG. 3 is a side perspective view of one embodiment of the present invention attached over a stake having a rectangular cross-section.

FIG. 4 is a bottom sectional view along line 4-4 of FIG. 2.

FIG. 5 is a bottom sectional view along line 5-5 of FIG. 3.

FIG. 6 is a bottom perspective view of one embodiment of the present invention.

FIG. 7 is a side sectional view along line 7-7 of FIG. 6.

FIG. 8 is a bottom sectional view of an embodiment of the present invention engaged over a cylindrical bolt having a larger diameter than that of FIG. 2.

FIG. 9 is a side sectional view along line 9-9 of FIG. 3.

FIG. 10 is a bottom plan view of an embodiment of the present invention.

FIG. 11 is a side sectional view along line 11-11 of FIG. 6.

### DETAILED DESCRIPTION

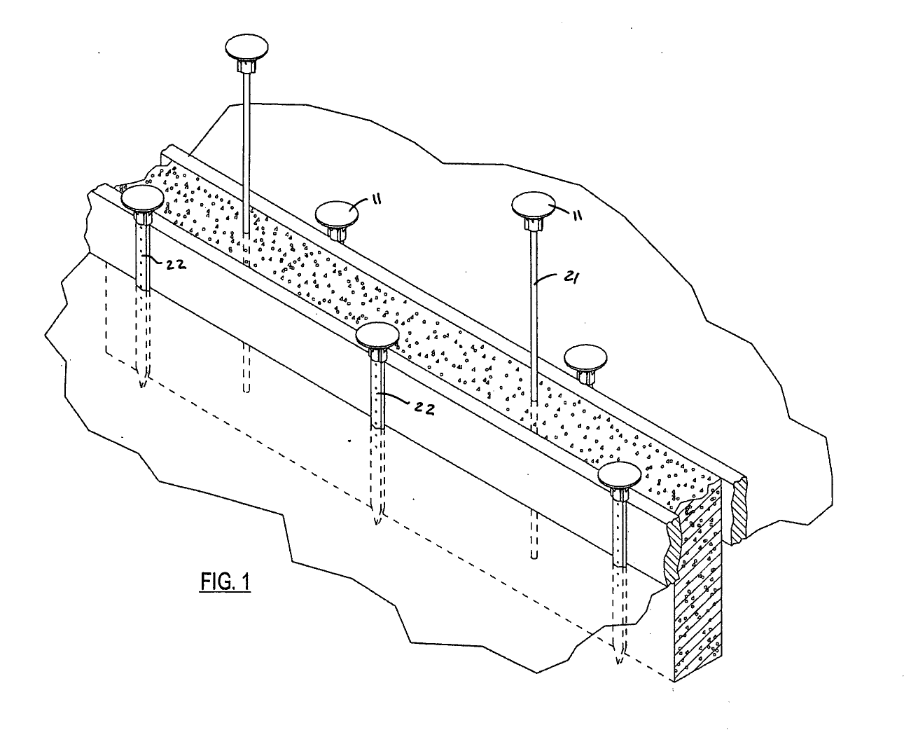

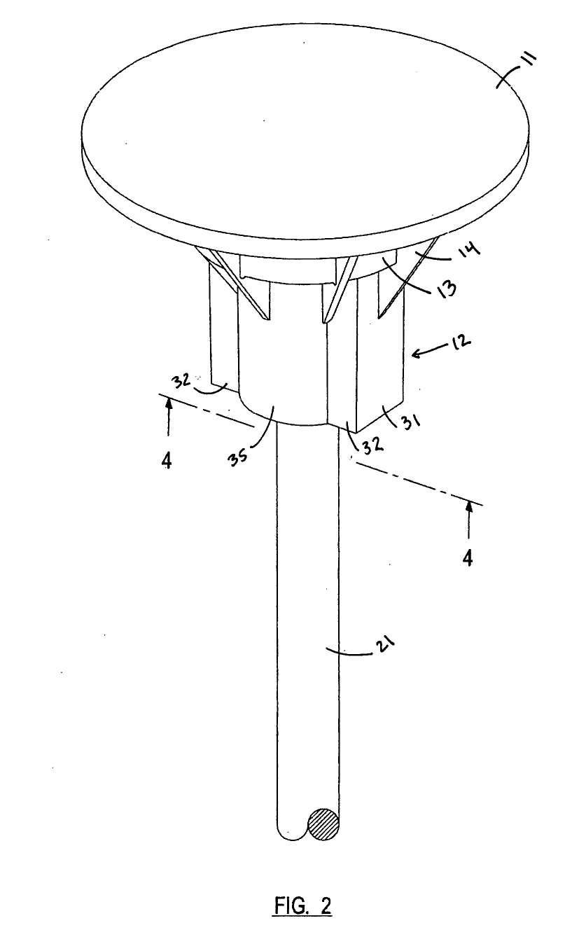

Referring to the exemplary embodiments of the drawings wherein like reference characters designate like or corresponding parts throughout the several views, and referring particularly to FIGS. 1 through 3, it is seen that the present invention includes a top portion or cap 11 that is attached to a specially shaped collar 12 having a hollow interior. In some embodiments, a reinforcing ring 13 may be provided underneath cap 11, and reinforcing ribs 14 may be provided between cap 11 and collar 12. In the illustrated embodiments, cap 11 is provided in the form of a disk, although it may have other shapes (such as a dome). Cap 11 may also be reinforced with an under plate 15 made of metal or other sturdy rigid material. The support structures 13, 14 and 15 help strengthen the invention in the event that someone falls onto it while it is attached to an anchor bolt 21 or stake 22.

Collar 12 is hollow, and is shaped so that it may receive a rod or shaft having a symmetrical and/or oblong cross-sectional shape. In particular, collar 12 is designed to receive rebar, studs, anchor bolts or the like having such symmetrical cross-sectional shapes as without limitation round, square, hexagonal, etc. In addition, collar 12 is designed to also receive shafts or stakes having oblong cross-sectional shapes such as without limitation rectangular, oval or other polygonal shapes.

In the illustrated exemplary embodiments, collar 12 includes a pair of end walls 31 attached to side walls 32 defining a generally rectangular shape with a hollow interior. In these embodiments, a central section 35 of each sidewall 32 is convex or arcuate such that it bulges out from the plane defined by the adjacent side wall 32. In the preferred embodiment, the convex central sections 35 are provided in both of the elongated parallel sidewalls 32. However, in other embodiments, a convex central section 35 may be provided on only one of the sidewalls 32, and/or on one or both of the end walls 31, and/or on any suitable combination of sidewall(s) 32 and/or endwall(s) 31. For example, only one convex wall 35 may be needed for a stud having a triangular cross-sectional shape. In other embodiments, bulging walls 35 may be eliminated entirely. Walls 31, 32 and 35 should have sufficient length to slide down over, for example, about an inch, more or less, of the top of a rebar, stud, anchor bolt, shaft, or stake so that sideward or upward pressure on the collar 12 does not easily dislodge it.

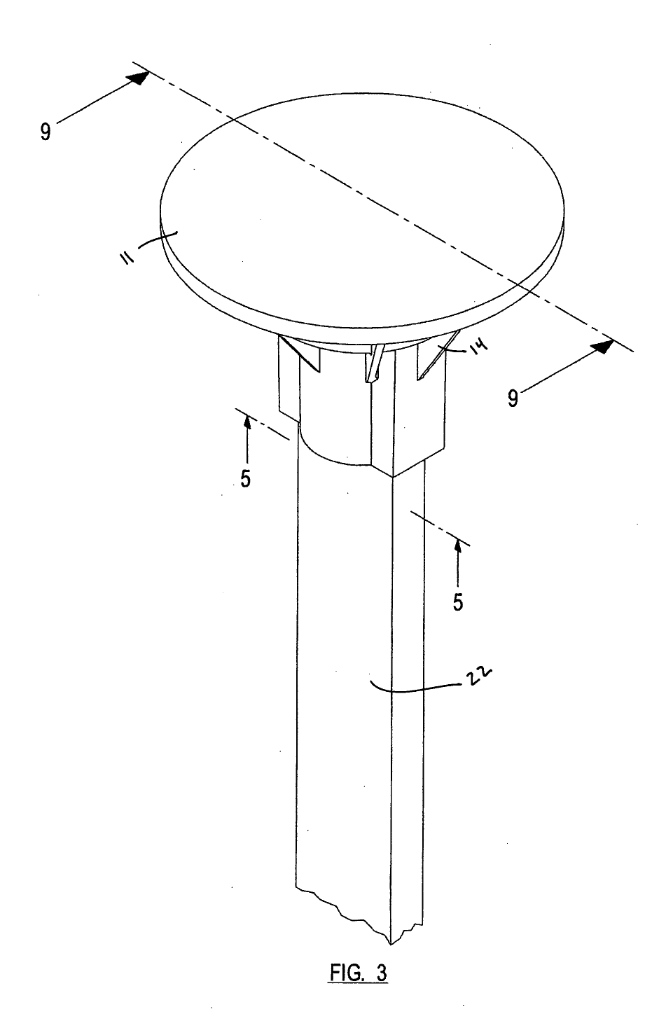

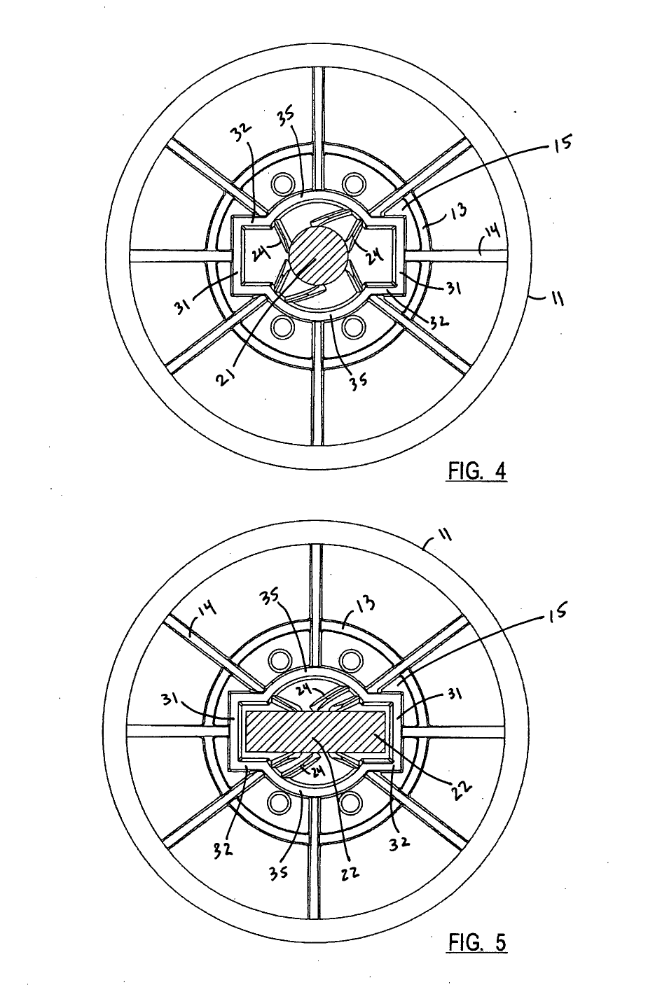

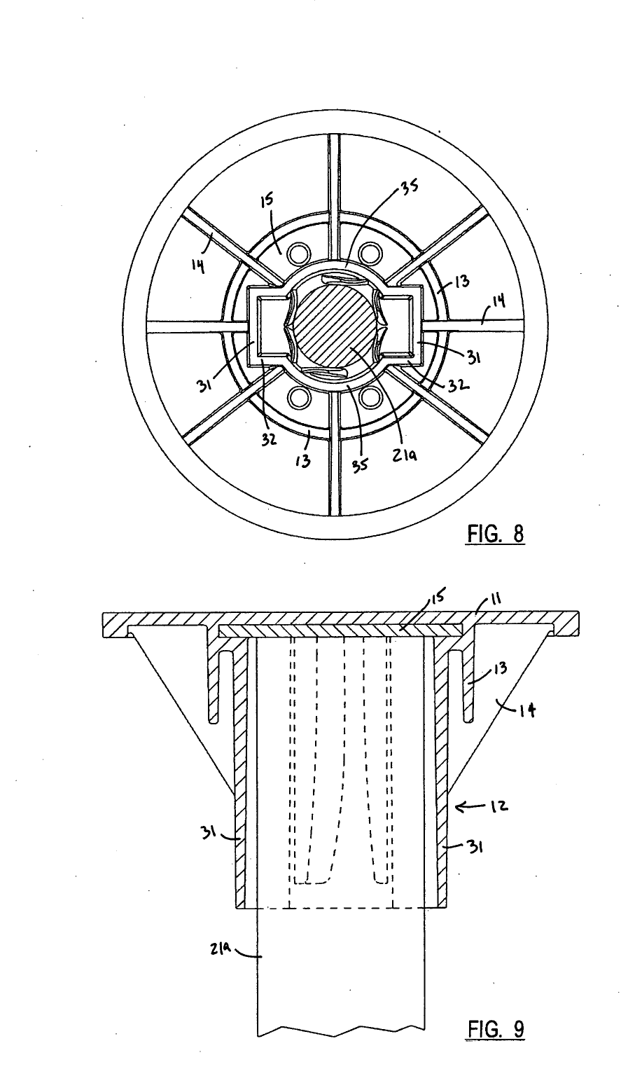

Referring to the cross-sectional views of the exemplary embodiments of FIGS. 4, 5 and 8, it is seen that convex walls 35 may define portions of a central circular region that may be concentric with the shape of the cap 11 and support 13. Regardless of the exact shape, the central region defined by the bulging walls 35 allows the collar 12 to receive a round, square, hexagonal or other symmetrical shaft, as illustrated in FIGS. 4 and 8. Walls 31 and 32 define a more rectangular shape, allowing collar 12 to also receive a shaft having a rectangular or oblong shape, as illustrated in FIG. 5. It is to be appreciated that the location of the bulging section defined by walls 35 is not limited to the center of walls 31 or 32. In some embodiments, the bulging section may be offset from the central axis of the rectangular form defined by walls 31 and 32.

Certain construction industries and projects may only utilize small anchor bolts and/or rebar 21, while other industries and projects may require larger anchor bolts and/or rebar 21a, or anchor bolts and stakes 22 of different shapes. The shape of the collar 12, and the protruding flanges 24 described below, allows the same device of the present invention to be utilized in each of those situations, allowing use over a wide range of different sizes and shapes. In addition, so long as the flanges 24 have not been damaged, the caps of the present invention may be removed and re-used multiple times.

The form of walls 31, 32 need not necessarily be rectangular, and may be varied so as to accommodate reception of rebar, studs, bolts, shafts, and/or stakes of various sizes and shapes in order to accommodate different construction industries and projects. Collar 12 is not limited to only rectangular and/or partially circular forms. It may be provided in other forms (e.g., hexagonal or any other polygonal) as well. Furthermore, additional forms may be included in addition to the preferred forms merely by revising the orientation and/or position of the existing forms vis-à-vis one another.

In most embodiments, cap 11, supports 13, 14 and walls 31, 32 and 35 should be constructed of sturdy, rigid materials. However, semi-deformable materials may be used for some or all of these structures in some circumstances to allow the invention to further accommodate shafts 21, 22 of irregular sizes and/or shapes, such as polygonal shafts, or shafts subject to manufacturing defects or deformities.

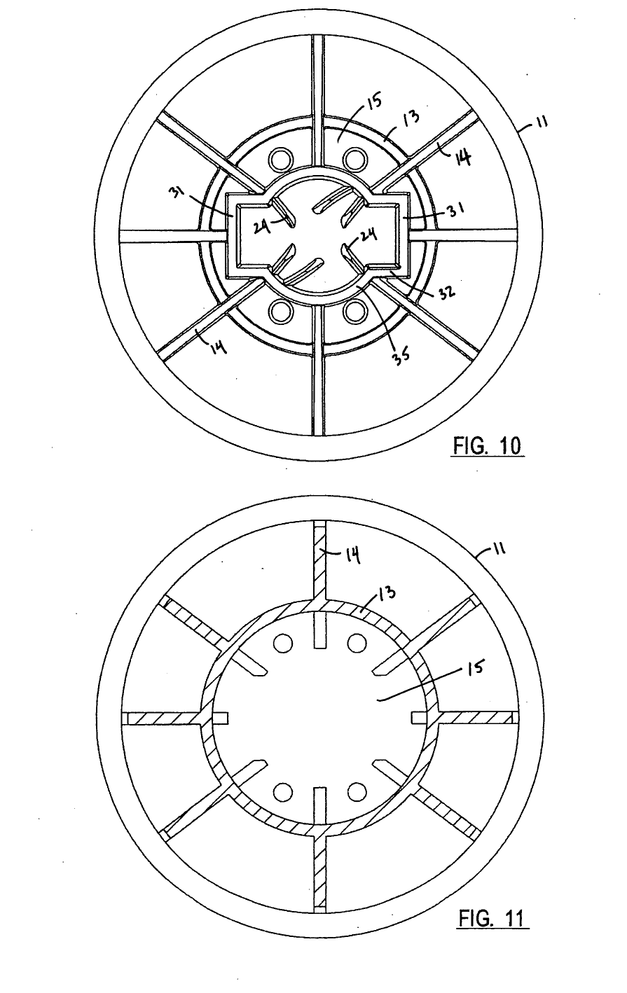

Referring to the exemplary embodiment of FIGS. 6, 7 and 10, it is seen that the interior of collar 12 is provided with a plurality of deformable flanges 24 that protrude inward. Flanges 24 are provided on the insides of walls 31, 32 and/or 35 and are designed to be pushed aside (deformed) by an incoming shaft 21, 22 so that they press firmly against the sides of the shaft as illustrated in FIGS. 4, 5 and 8. This pressure holds the cap firmly in place on top of a shaft 21, 22 such as a rebar, stud, anchor bolt, or stake. In some embodiments, flanges 24 may protrude radially inwardly. In other embodiments, flanges 24 may protrude inward in a uniform or non uniform manner. One end of each flange is affixed to the interior of one of walls 31, 32 or 35, with the other end extending freely into the central space defined by collar 12. As shown in FIGS. 4-6, the flanges 24 deform as the shaft 21, 22 is inserted into collar 12 in order to conform to the size and shape of the shaft. Such securement may be effected either by the flanges 24 lodging within the threads of an anchor bolt 21, or by the flanges 24 contacting the surfaces of the bolt 21 or stake 22 and frictionally securing it within the collar 12. The surfaces of flanges 24 may be rough in order to provide additional frictional securement, or smooth to allow for easier installation and removal. In either event, flanges 24 eliminate the necessity for any extraneous attachment means such as cotter pins, securing bolts or nuts. The illustrated embodiments utilize six flanges 24, three on each side, which is preferred for round shafts, stakes or anchor bolts. However, any suitable number of flanges 24 may be used (e.g. from three to twelve or more) so long as space allows, including an odd number.

The shape and extent of the deformation undergone by flanges 24 will generally depend upon the particular shape and size of the shaft over which the cap is attached. For example, in FIG. 4, the illustrated anchor bolt 21 has a round cross-section, and has a smaller diameter than the one shown in FIG. 8. The flanges 24 extend inward and contact the surface of the shaft over which the cap is attached, usually without any direct contact between the shaft and the interior surface of the walls of collar 12. In many embodiments, when an object having a round cross section is inserted, flanges 24 form a wall around it. The firm contact between the flanges 24 and the shaft 21, 22 is superior to a traditional safety cap having an annular column with no interior flanges. Such a traditional safety cap would be too large for the bolt 21, and would not allow the safety cap to remain securely attached to it, resulting in an increased risk of dislodgment, tripping and/or impalement injury.

FIG. 5 illustrates an exemplary embodiment in which the flanges 24 are engaged against a stake (shaft) 22 having a rectangular cross-section. In this illustration, it is seen that the elongated stake 22 extends into the generally rectangular portion of the collar defined by walls 31 and 32, but not into the central arcuate areas defined by walls 35. The versatility of the invention allows the same device to receive either a round shaft (FIG. 4) or a rectangular shaft (FIG. 5), and still be held tightly in place by flanges 24. It is apparent that flanges 24 allow the present invention to be used with irregularly or unusually shaped rebar, studs, anchor bolts, stakes or shafts (21, 22, etc.), in that each flange 24 is independently deformable vis-à-vis the corresponding surface area of the inserted shaft. Thus, it is largely irrelevant that the collar 12 itself may be larger than the diameter of the rebar, stud, anchor bolt 21 or stake 22 over which it is attached, so long as the inwardly extending flanges make secure contact with it. Some construction industries or projects may regulate the ability of the safety cap to withstand a minimum amount of dislodgment force, which may be accommodated by using stronger, weaker, longer and/or shorter flanges 24.

It should further be appreciated that the flanges 24 may take on different positions and forms. For example, the edges of the flanges 24 may be curved to permit easier insertion over the shaft. Flanges 24 may also have different tiers of protrusion, which represent stepped “lips” for anchor shafts of different dimensions. This allows the flanges 24 to better conform to the particular dimensions of each anchor bolt 21 or stake 22, and further improves the securement of the safety cap. Flanges may be provided in numerous forms other than those illustrated that may be utilized for the same purpose, including, but not limited to, teeth, prongs, grooves, clips, or any other engagement member that makes secure contact with the surface of the shaft/bolt/stud/stake over which the safety cap of the present invention is to be attached.

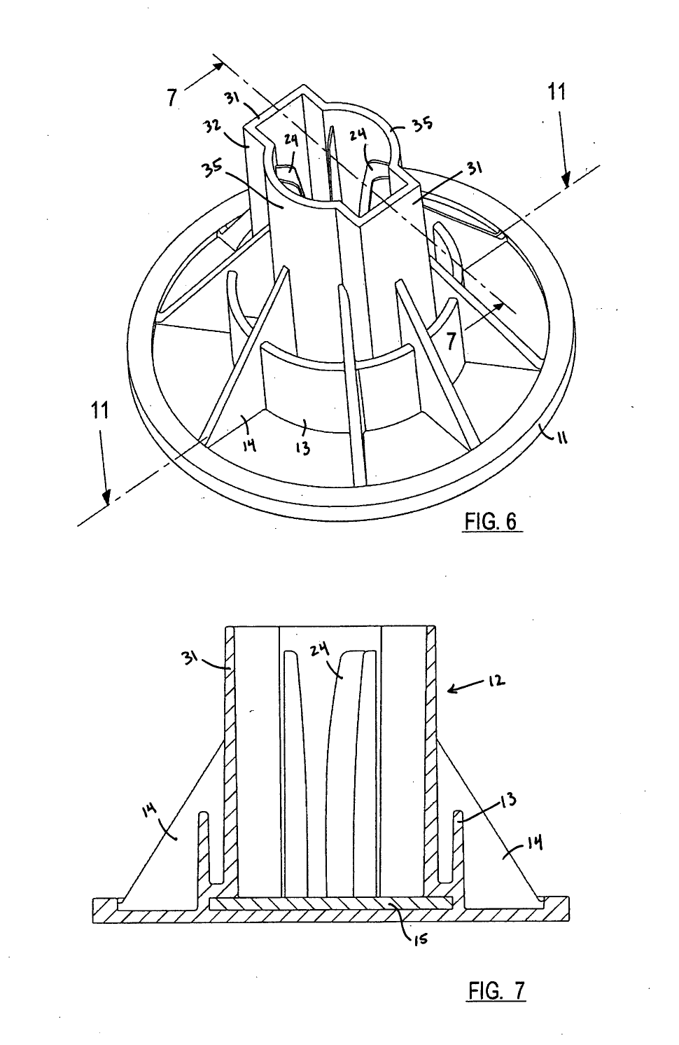

In some embodiments of the present invention, disk or dome 11 may be made of a stronger material such as metal or high-strength plastic to prevent breakage (potentially leading to impalement) in the event a person falls onto a shaft to which the invention has been attached. In other embodiments, a metallic or other rigid interior piece 15 may be installed in or underneath disk 11 for the same purpose, as shown, for example, in the cross sectional views of FIGS. 7 and 9. Such a piece 15 may be small, extending only around collar 12; it may be large, extending to the diameter of disk 11; or it may be sized to extend part way between the edge of collar 12 and disk 11. The surface of disk 11 should be readily recognizable on a construction site, to minimize impalement injuries, and avoid tripping injuries. Among other things, the preferred embodiments of the disks 11 of the present invention are brightly colored and have diameters that are much larger than the shafts/rebar/bolts/studs/stakes over which they are placed.

Alternative embodiments of the present invention allow for the upper disc 11 to be removable from collar 12. Other embodiments include a wall support bracket and/or a top end of the collar 12 that permits attachment of any number of objects, such as customized interchangeable safety surfaces, flags, or audio alert devices. A further alternative embodiment provides a single safety surface 11 for use over several upwardly protruding shafts/rebar/bolts/studs/stakes that are in close proximity to one another, either with or without adjustable positions for each collar 12 (via rails or any other adjustment mechanism), whereby the safety surface 11 covers a larger area (see, e.g., United States Patent Application No. 2007/0215784) or may be used for other purposes, such as a temporary work-bench.

In embodiments of the present invention utilizing a safety surface 11 that is substantially larger than collar 12, there is a risk that downward pressure exerted upon the safety surface 11 may cause the surface 11 to deform or break. Such risk may be minimized by utilizing one or more support brackets 14 with the collar 12. Said support brackets 14 are positioned to contact the bottom side of the safety surface 11, and to support the downward pressure upon said surface. However, it should be appreciated that support brackets 14 are not essential elements of the present invention, and that the downward pressure may be absorbed via any number of other devices, including, but not limited to, sturdier safety surfaces or safety surfaces supported by multiple collars 12 (see, e.g., United States Patent Application No. 2007/0215784). It is to be understood that different embodiments of the present invention may be made from different combinations of the features described above, and that other variations and modifications of the present invention may be made without departing from the scope thereof. It is further to be understood that the present invention is not to be limited by the specific embodiments disclosed herein, but only in accordance with the appended claims when read in light of the foregoing specification.

What is claimed is:

1. A safety cap for attachment to an end of a shaft comprising:
a. a collar made up of four walls defining a generally rectangular opening for receiving a portion of the end of said shaft, wherein at least one of said walls includes an arcuate section;
b. a cover member attached over an open end of said collar; and
c. a plurality of deformable flanges attached to said collar, said flanges extending into said opening.

2. The safety cap of claim 1 wherein a plurality of said walls include arcuate sections.

3. The safety cap of claim 1 wherein a pair of opposing walls include arcuate sections.

4. The safety cap of claim 3 wherein said deformable flanges are attached to said arcuate sections.

5. The safety cap of claim 4 wherein at least four deformable flanges are provided and at least two such flanges are attached to each arcuate section.

6. The safety cap of claim 4 wherein three deformable flanges are attached to each arcuate section.

7. The safety cap of claim 1 wherein said cover includes a rigid reinforcement piece.

8. The safety cap of claim 7 wherein said reinforcement piece is made of metal.

9. The safety cap of claim 1 wherein at least one support flange is provided connecting said cover with said collar.

10. The safety cap of claim 9 wherein a support ring is provided around said collar.

11. The safety cap of claim 1 wherein said cover is in the form of a dome.

12. A safety cap for a shaft comprising:
a. a collar having a hollow interior for receiving an upper portion of said shaft, said collar further comprising a peripheral wall having straight, angled and curved portions included therein;
b. a plurality of deformable engagement members attached to said peripheral wall and extending inward into said interior for engagement against said upper portion of said shaft; and
c. a cover provided at one end of said collar.

13. The safety cap of claim 12 wherein at least two opposing curved portions are provided in said peripheral wall, and at least three deformable members are attached to each such curved portion.

14. The safety cap of claim 12 wherein said cover has a surface area that is greater than the area within said peripheral wall.

15. A safety cap for attachment to an end of a shaft comprising:
a. a collar made up of four walls defining a generally rectangular opening for receiving a portion of the end of said shaft, wherein each of a pair of opposing walls of said collar includes a convex section;
b. a cover member attached over an open end of said collar; and
c. a plurality of deformable flanges attached to said collar and extending into said opening for engagement against said shaft.

16. The safety cap of claim 15 wherein said deformable flanges are attached to said convex sections.

17. The safety cap of claim 15 wherein three deformable flanges are attached to each convex section.

18. The safety cap of claim 15 wherein said cover includes a metallic reinforcement piece.

19. The safety cap of claim 14 wherein said cover is in the form of a dome.
